(19) United States
(12) Patent Application Publication
(10) Pub. No.: US 2022/0297962 A1
(43) Pub. Date: Sep. 22, 2022

(54) MEDIUM CONVEYING APPARATUS PROVIDING MAINTENANCE-RELATED NOTIFICATION BASED ON SKEW OF MEDIUM

(71) Applicant: PFU LIMITED, Kahoku-shi (JP)

(72) Inventor: Naofumi Kado, Kahoku-shi (JP)

(21) Appl. No.: 17/650,820

(22) Filed: Feb. 11, 2022

(30) Foreign Application Priority Data
Mar. 17, 2021 (JP) 2021-044126

(51) Int. Cl. B65H 7/06; G07C 3/00

(52) U.S. Cl. CPC B65H 7/06; G07C 3/005; B65H 2557/652; B65H 2601/324

(57) ABSTRACT

A medium conveying apparatus includes a conveying unit including a conveyance roller to convey a medium and a processor. The processor detects a skew of a medium conveyed by the conveying unit, calculates an occurrence frequency of skew based on a detection result, and outputs a first notification related to maintenance of the conveyance roller or a second notification not related to the maintenance based on the occurrence frequency.

### CROSS-REFERENCE TO RELATED APPLICATIONS

This application is based upon and claims the benefit of priority of prior Japanese Patent Application No. 2021-044126, filed on Mar. 17, 2021, the entire contents of which are incorporated herein by reference.

### TECHNICAL FIELD

The present invention relates to a medium conveying technology.

### BACKGROUND

A medium conveying apparatus such as a scanner conveys a medium being an original with a conveyance roller. When the conveyance roller is contaminated or abraded, conveyance of the medium in a tilted manner, that is, a skew may occur. When a skew of a medium occurs, the medium conveying apparatus cannot suitably read the medium, and therefore a user needs to perform maintenance such as cleaning or replacement of the conveyance roller.

A reading apparatus detecting a change in an amount of oblique movement of a conveyed original on the basis of read data of the original and making a notification for prompting cleaning or replacement of a roller on the basis of the change in an amount of oblique movement is known (see Japanese Unexamined Patent Publication (Kokai) No. 2016-50061).

### SUMMARY

According to some embodiments, a medium conveying apparatus includes a conveying unit including a conveyance roller to convey a medium and a processor. The processor detects a skew of a medium conveyed by the conveying unit, calculates an occurrence frequency of skew based on a detection result, and outputs a first notification related to maintenance of the conveyance roller or a second notification not related to the maintenance based on the occurrence frequency.

According to some embodiments, a control method for a medium conveying apparatus including a conveying unit including a conveyance roller for conveying a medium, includes detecting a skew of a medium conveyed by the conveying unit, calculating an occurrence frequency of skew based on a detection result, and outputting a first notification related to maintenance of the conveyance roller or a second notification not related to the maintenance based on the occurrence frequency.

According to some embodiments, a computer-readable, non-transitory medium stores a computer program. The computer program causes a medium conveying apparatus including a conveying unit including a conveyance roller for conveying a medium to execute a process. The process includes detecting a skew of a medium conveyed by the conveying unit, calculating an occurrence frequency of skew based on a detection result, and outputting a first notification related to maintenance of the conveyance roller or a second notification not related to the maintenance based on the occurrence frequency.

### BRIEF DESCRIPTION OF DRAWINGS

FIG. 1 is a perspective view of a medium conveying apparatus 100.

FIG. 2 is a diagram for illustrating a conveyance path of a medium.

FIG. 3 is a schematic diagram for illustrating a driving mechanism of a feed roller 113.

FIG. 4 is a diagram for illustrating an example of placement of second medium sensors.

FIG. 5 is a block diagram illustrating an example of a schematic configuration of the medium conveying apparatus 100.

FIG. 6 is a block diagram illustrating an example of schematic configurations of a storage device 140 and a processing circuit 150.

FIG. 7 is a flowchart illustrating an example of medium reading processing.

FIG. 8 is a flowchart illustrating an example of detection processing.

FIG. 9 is a flowchart illustrating an example of notification processing.

FIG. 10 is a block diagram illustrating an example of a schematic configuration of a processing circuit 250.

### DESCRIPTION OF EMBODIMENTS

It is to be understood that both the foregoing general description and the following detailed description are exemplary and explanatory, and are not restrictive of the invention, as claimed.

Hereinafter, a medium conveying apparatus, a control method, and a computer-readable, non-transitory medium storing a computer program according to an embodiment, will be described with reference to the drawings. However, it should be noted that the technical scope of the invention is not limited to these embodiments, and extends to the inventions described in the claims and their equivalents.

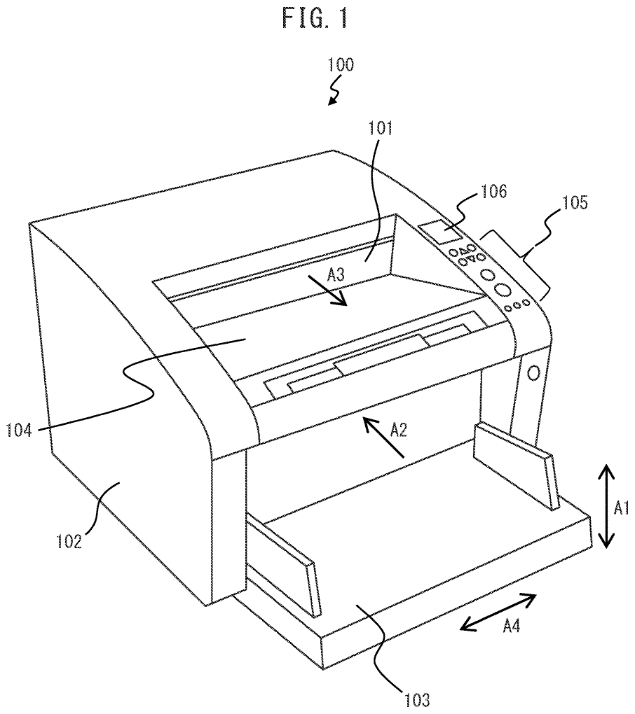

FIG. 1 is a perspective view illustrating a medium conveying apparatus 100 configured as an image scanner. The medium conveying apparatus 100 conveys and images a medium being an original. The medium conveying apparatus 100 may be a facsimile, a copying machine, a multifunctional peripheral (MFP). Further, the medium conveying apparatus 100 may be a printer, and in this case, a conveyed medium is an object being printed on.

The medium conveying apparatus 100 includes a first housing 101, a second housing 102, a loading tray 103, an output tray 104, an operation device 105, and a display device 106.

The first housing 101 is arranged at the upper side of the medium conveying apparatus 100. The first housing 101 is engaged with the second housing 102 by a hinge in such a way as to be openable in a case of a medium being stuck, cleaning inside the medium conveying apparatus 100 being performed, or the like.

The loading tray 103 is engaged with the second housing 102 in such a way as to be able to place a conveyed medium. The loading tray 103 is provided on the lateral surface of a medium feeding side of the second housing 102 to be movable by an unillustrated motor in an almost vertical direction (height direction) A1. The loading tray 103 is placed at a lower end position in such a way that a medium can be easily placed when a medium is not conveyed, and is raised to a position where a medium placed on the uppermost side is in contact with a pick roller to be described later when a medium is conveyed. The output tray 104 is formed on the first housing 101 in such a way as to be able to hold ejected media and loads the ejected media.

The operation device 105 includes an input device such as a button and an interface circuit acquiring a signal from the input device. The operation device 105 receives input operation by a user, and outputs an operation signal based on the input operation by the user. The display device 106 includes a display such as a liquid crystal display or organic electro-luminescence (EL) display, and an interface circuit outputting image data to the display. The display device 106 displays the image data on the display.

In FIG. 1, an arrow A2 indicates a medium conveying direction, an arrow A3 indicates a medium ejecting direction, and an arrow A4 indicates a width direction orthogonal to the medium conveying direction. An upper stream hereinafter refers to an upper stream in the medium conveying direction A2 or the medium ejecting direction A3, and a lower stream refers to a lower stream in the medium conveying direction A2 or the medium ejecting direction A3.

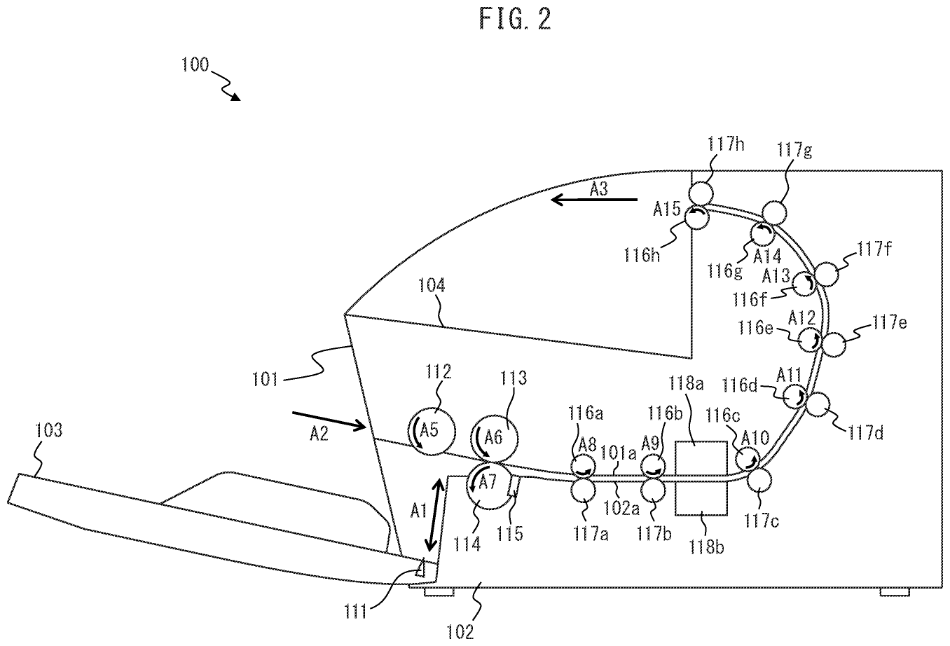

FIG. 2 is a view for illustrating a conveyance path inside the medium conveying apparatus 100. The conveyance path inside the medium conveying apparatus 100 includes a first medium sensor 111, a pick roller 112, a feed roller 113, a brake roller 114, a second medium sensor 115, first to eighth conveyance rollers 116a to h, first to eighth driven rollers 117a to h, a first imaging device 118a, and a second imaging device 118b. The first imaging device 118a and the second imaging device 118b may be hereinafter collectively referred to as an imaging device 118.

The number of each of the pick roller 112, the feed roller 113, the brake roller 114, and the first to eighth conveyance rollers 116a to 116h and/or the first to eighth driven rollers 117a to 117h is not limited to one and may be more than one. In that case, the plurality of pick rollers 112, feed rollers 113, brake rollers 114, first to eighth conveyance rollers 116a to 116h and/or first to eighth driven rollers 117a to 117h are spaced in the width direction A4.

A surface of the first housing 101 facing the second housing 102 forms a first guide 101a of a conveyance path of a medium. A surface of the second housing 102 facing the first housing 101 forms a second guide 102a of the conveyance path of a medium.

The first medium sensor 111 is arranged on the loading tray 103, in other words, on the upstream side of the feed roller 113 and the brake roller 114. The first medium sensor 111 detects a placement state of a medium on the loading tray 103. The first medium sensor 111 determines whether or not a medium is placed on the loading tray 103 by a contact detection sensor passing a current when a medium is in contact with the sensor or when a medium is not in contact with the sensor. The first medium sensor 111 generates and outputs a first medium signal the signal value of which varies between a state in which a medium is placed on the loading tray 103 and a state in which a medium is not placed. The first medium sensor 111 is not limited to a contact detection sensor, and any other sensor capable of detecting existence of a medium, such as a light detection sensor, may be used as the first medium sensor 111.

The pick roller 112 is provided on the first housing 101. The pick roller 112 comes in contact with a medium placed on the loading tray 103 raised to a height almost identical to that of the medium conveyance path, and feeds the medium toward the downstream side.

The feed roller 113 is provided inside the first housing 101 on the downstream side of the pick roller 112. The feed roller 113 feeds and conveys a medium fed by the pick roller 112 further toward the downstream side. The brake roller 114 is placed inside the second housing 102 in such a way as to face the feed roller 113. The feed roller 113 and the brake roller 114 perform a separation operation of a medium by separating media and feeding one medium at a time. The feed roller 113 is placed above the brake roller 114, and the medium conveying apparatus 100 feeds a medium by a so-called top-first scheme.

The second medium sensor 115 is placed on the downstream side of the feed roller 113 and the brake roller 114. The second medium sensor 115 is an example of a medium detection sensor and detects whether or not a medium exists at the position of the second medium sensor 115. The second medium sensor 115 is a recurrent prism sensor and includes a light-emitting element, a photodetector, and a light-guiding member.

The light-emitting element and the photodetector are arranged outside the medium conveyance path with the second guide 102a in between. The light-guiding member is a light-guiding tube such as a U-shaped prism and is placed outside the medium conveyance path in such a way that both ends face the light-emitting element and the photodetector, respectively, with the first guide 101a in between. The light-emitting element is a light-emitting diode (LED) or the like and projects light toward the light-guiding member with the medium conveyance path in between. The photodetector receives light being projected from the light-emitting element and being guided by the light-guiding member. The photodetector generates and outputs a second medium signal being an electric signal based on intensity of the received light. When a medium exists at the position of the second medium sensor 115, light projected from the light-emitting element is shaded by the medium, and therefore the signal value of the second medium signal varies between a state in which a medium exists at the position of the second medium sensor 115 and a state in which a medium does not exist.

The configuration of the second medium sensor 115 is not limited to the aforementioned example. For example, a reflection member such as a mirror may be used in place of the light-guiding member. Further, the second medium sensor 115 may be configured only with the light-emitting element and the photodetector. In this case, the light-emitting element and the photodetector are placed on the first housing 101 and the second housing 102, respectively, in such a way as to face each other with the medium conveyance path in between. Further, the second medium sensor 115 may be a contact detection sensor similar to the first medium sensor 111.

The first to eighth conveyance rollers 116a to 116h and the first to eighth driven rollers 117a to 117h are provided on the downstream side of the feed roller 113 and the brake roller 114 and convey a medium fed by the feed roller 113 and the brake roller 114 toward the downstream side. The first to eighth conveyance rollers 116a to 116h and the first to eighth driven rollers 117a to 117h are placed in such a way as to face one another, respectively, with the medium conveyance path in between.

The first imaging device 118a is provided on the downstream side of the first and second conveyance rollers 116a and 116b and the first and second driven rollers 117a and 117b in the medium conveying direction A2. The first imaging device 118a includes a line sensor based on a unit magnification optical system type contact image sensor (CIS) including complementary metal oxide semiconductor-(CMOS-) based imaging elements linearly arranged in a main scanning direction. The first imaging device 118a includes lenses each forming an image on an imaging element and an A/D converter amplifying and analog-digital (A/D) converting an electric signal output from the imaging element. The first imaging device 118a generates and outputs an input image, which is an image captured of the front surface of the conveyed document.

The second imaging device 118b is provided on the downstream side of the first and second conveyance rollers 116a and 116b and the first and second driven rollers 117a and 117b in the medium conveying direction A2. The second imaging device 118b includes a line sensor based on a unit magnification optical system type contact image sensor (CIS) including complementary metal oxide semiconductor-(CMOS-) based imaging elements linearly arranged in the main scanning direction. The second imaging device 118b includes lenses each forming an image on an imaging element and an A/D converter amplifying and analog-digital (A/D) converting an electric signal output from the imaging element. The second imaging device 118b generates and outputs an input image, which is an image captured of the back surface of the conveyed document.

Only one of the first imaging device 118a and the second imaging device 118b may be provided in the medium conveying apparatus 100. In this case, only one side of a medium may be read. A line sensor based on a unit magnification optical system type CIS including charge coupled device-(CCD-) based imaging elements may be used in place of the line sensor based on a unit magnification optical system type CIS including CMOS-based imaging elements. A reduction optical system type line sensor including CMOS- or CCD-based imaging elements may be used.

A medium placed on the loading tray 103 is conveyed between the first guide 101a and the second guide 102a in the medium conveying direction A2 by the pick roller 112 and the feed roller 113 rotating in medium feeding directions A5 and A6, respectively. When a plurality of media are placed on the loading tray 103, only a medium in contact with the feed roller 113 out of the media placed on the loading tray 103 is separated by the brake roller 114 rotating in a direction A7 opposite to the medium feeding direction.

A medium is fed to an imaging position of the imaging device 118 by the first and second conveyance rollers 116a and 116b rotating in directions of arrows A8 and A9, respectively, while being guided by the first guide 101a and the second guide 102a and is imaged by the imaging device 118. Furthermore, the medium is ejected onto the output tray 104 by the third to eighth conveyance rollers 116c to 116h rotating in directions of arrows A10 to A15, respectively. The output tray 104 loads media ejected by the eighth conveyance roller 116h.

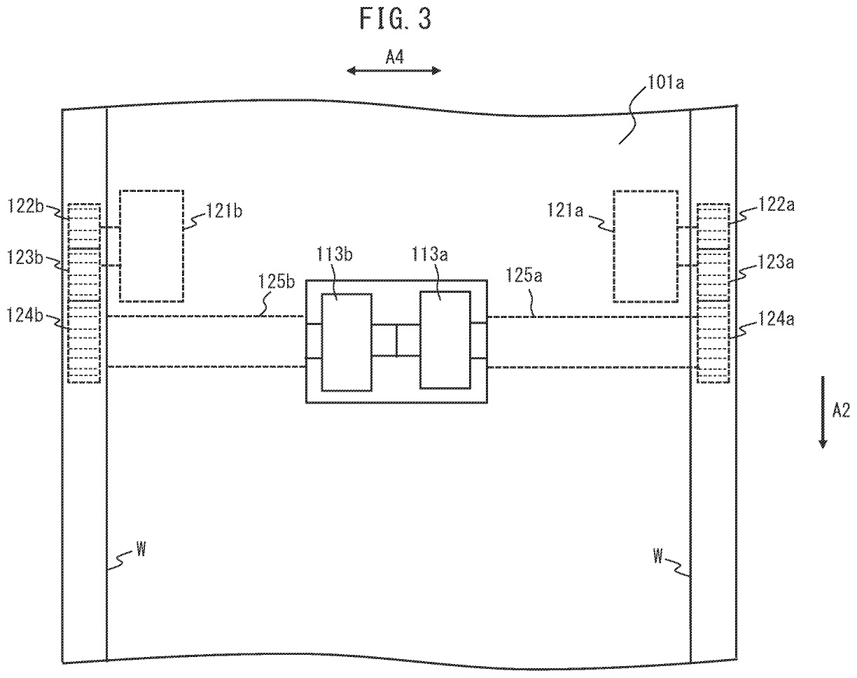

FIG. 3 is a schematic diagram for illustrating a driving mechanism of the feed roller 113. FIG. 3 is a schematic diagram of the first housing 101 viewed from below.

In an example illustrated in FIG. 3, the medium conveying apparatus 100 includes two feed rollers 113a and 113b. A driving mechanism of the feed roller 113a includes a motor 121a, a plurality of gears 122a, 123a, and 124a, and a shaft 125a. The motor 121a, the plurality of gears 122a, 123a, and 124a, and the shaft 125a are arranged inside the first housing 101. The gears 122a, 123a, and 124a are arranged outside a side wall W of the conveyance path. The motor 121a generates a driving force for rotating the feed roller 113a in accordance with a control signal from a processing circuit to be described later. The gear 122a is mounted on the rotation axis of the motor 121a and is engaged with the gear 123a; and the gear 123a is engaged with the gear 124a. The gear 124a is mounted on the shaft 125a; and the feed roller 113a is further detachably mounted on the shaft 125a.

A driving mechanism of the feed roller 113b includes a motor 121b, a plurality of gears 122b, 123b, and 124b, and a shaft 125b. The motor 121b, the plurality of gears 122b, 123b, and 124b, and shaft 125b are arranged inside the first housing 101. The gears 122b, 123b, and 124b are arranged outside the side wall W of the conveyance path. The motor 121b generates a driving force for rotating the feed roller 113b in accordance with a control signal from the processing circuit to be described later. The gear 122b is mounted on the rotation axis of the motor 121b and is engaged with the gear 123b; and the gear 123b is engaged with the gear 124b. The gear 124b is mounted on the shaft 125b; and the feed roller 113b is further detachably mounted on the shaft 125b.

Each of the feed rollers 113a and 113b is an example of a conveyance roller for conveying a medium. Each of the feed rollers 113a and 113b and the driving mechanism of each of the feed rollers 113a and 113b constitute an example of a conveying unit. The feed rollers 113a and 113b are removably provided in the conveying unit by being detachably mounted on the shafts 125a and 125b, respectively. The feed rollers 113a and 113b are provided to be independently rotatable by the motors 121a and 121b, respectively.

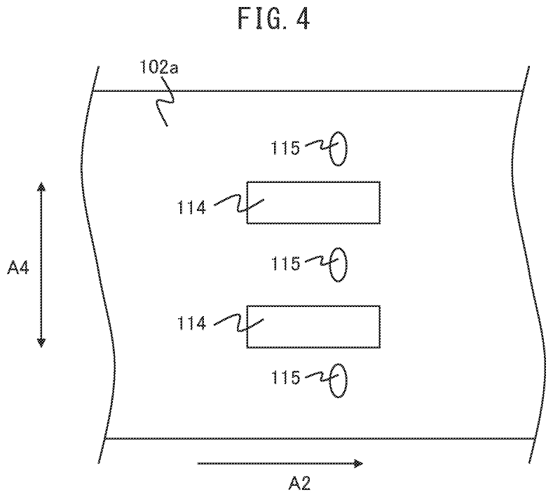

FIG. 4 is a diagram for illustrating an example of arrangement of the second medium sensors 115. FIG. 4 is a schematic diagram of the first housing 101 viewed from above in a state in which the second housing 102 is opened.

In the example illustrated in FIG. 4, two brake rollers 114 and three second medium sensors 115 are arranged on the second guide 102a. The brake rollers 114 are spaced along the width direction A4. The second medium sensors 115 are arranged at positions identical to each other in the medium conveying direction A1 and are placed outside and inside the two brake rollers 114 in the width direction A4, respectively. The three second medium sensors 115 are placed at positions identical to the positions of roller nips of the brake rollers 114 and the feed roller 113 in the medium conveying direction A2. The distance between the second medium sensor 115 placed outside in the width direction A4 and the brake roller 114 is set in such a way that when a medium with a minimum length supported by the medium conveying apparatus 100 in the width direction A4 is conveyed, the medium passes over the second medium sensor 115.

The number of second medium sensors 115 is not limited to three and may be any number greater than or equal to two. The plurality of second medium sensors 115 may be provided on the downstream side of the positions of the roller nips of the brake rollers 114 and the feed roller 113.

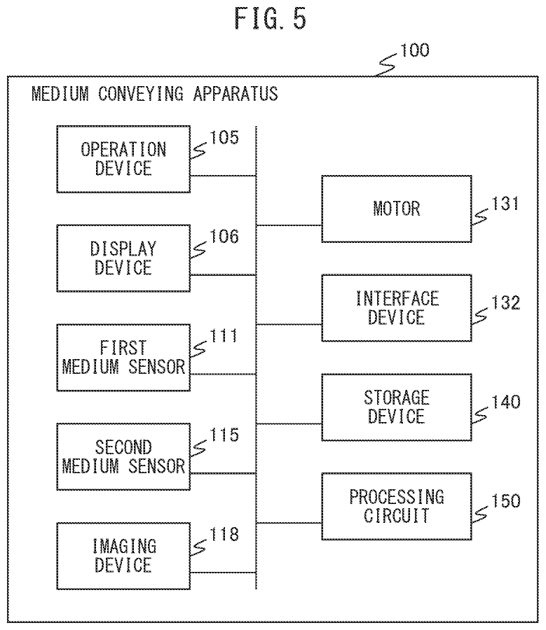

FIG. 5 is a diagram illustrating an example of a schematic configuration of the medium conveying apparatus 100. In addition to the configuration described above, the medium conveying apparatus 100 further includes a motor 131, an interface device 132, a storage device 140, and a processing circuit 150.

The motor 131 includes one or a plurality of motors including the motors 121a and 121b driving the feed roller 113. The motor 131 feeds and conveys a medium by rotating the pick roller 112, the feed roller 113, the brake roller 114, and the first to eighth conveyance rollers 116a to 116h in accordance with a control signal from the processing circuit 150. The first to eighth driven rollers 117a to 117h may be provided to rotate by a driving force from a motor instead of being driven to rotate according to rotation of the conveyance rollers.

The interface device 132 includes an interface circuit conforming to a serial bus such as USB. The interface device 132 transmits and receives input images and various types of information by being electrically connected to an unillustrated information processing device such as a personal computer or a mobile terminal. A communication unit including an antenna transmitting and receiving wireless signals and a wireless communication interface circuit for transmitting and receiving signals through a wireless communication line in conformance with a communication protocol may be used in place of the interface device 132. For example, the communication protocol is a wireless local area network (LAN).

The storage device 140 includes a memory device such as a random access memory (RAM) or a read only memory (ROM), a fixed disk device such as a hard disk, or a portable storage device such as a flexible disk or an optical disk. The storage device 140 stores a computer program, a database, a table, etc., that are used for various processing of the medium conveying apparatus 100. The computer program may be installed on the storage device 140 from a non-transitory computer-readable portable recording medium by use of a known setup program. Examples of the portable recording medium include a compact disc read only memory (CD-ROM) and a digital versatile disc read only memory (DVD-ROM).

The storage device 140 stores a conveyed medium count and skew occurrence information as data. The conveyed medium count indicates the number of media being collectively placed on the loading tray 103 and being collectively conveyed. The skew occurrence information indicates a skew direction for each conveyed medium in which a skew occurs.

The processing circuit 150 is a circuit operating in accordance with a program previously stored in the storage device 140. Examples of the processing circuit 150 include a central processing unit (CPU). A digital signal processor (DSP), a large scale integration (LSI), an application specific integrated circuit (ASIC), a field-programmable gate array (FPGA), etc., may also be used as the processing circuit 150.

The processing circuit 150 is connected to the operation device 105, the display device 106, the first medium sensor 111, the second medium sensor 115, the imaging device 118, the motor 131, the interface device 132, the storage device 140, etc., and controls these components. The processing circuit 150 conveys a medium by controlling the motor 131, acquires an input image by controlling the imaging device 118, and transmits the acquired input image to the information processing device through the interface device 132. The processing circuit 150 detects a skew of a conveyed medium on the basis of a second medium signal received from the second medium sensor 115 and outputs a notification related to maintenance of the feed roller 113 or the like from the interface device 132 on the basis of an occurrence frequency of skew.

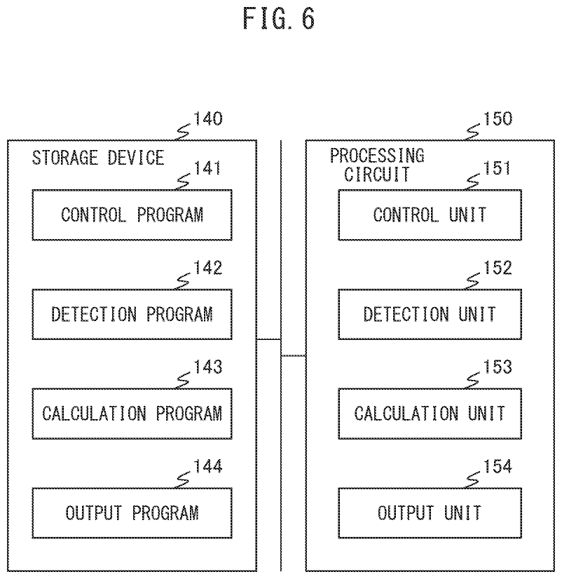

FIG. 6 is a diagram illustrating an example of schematic configurations of the storage device 140 and the processing circuit 150.

The storage device 140 stores programs such as a control program 141, a detection program 142, a calculation program 143, and an output program 144. Each of the programs is a functional module implemented by software operating on a processor. The processing circuit 150 functions as a control unit 151, a detection unit 152, a calculation unit 153, and an output unit 154 by reading each program stored in the storage device 140 and operating in accordance with the read program.

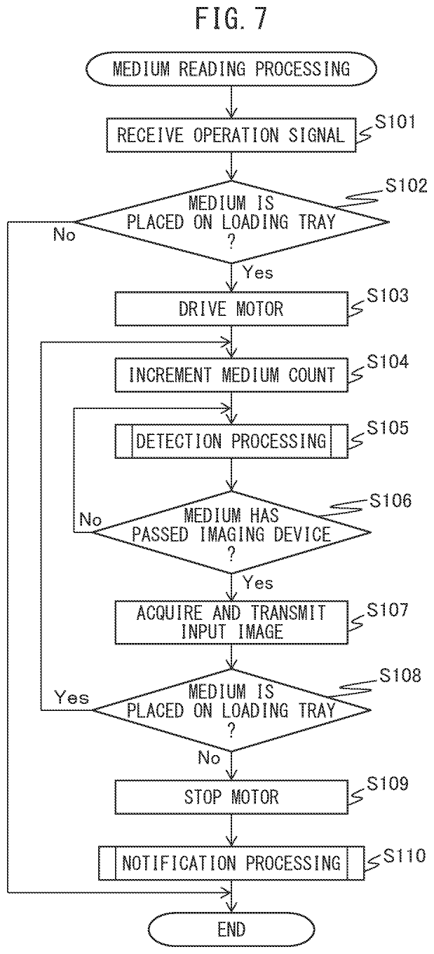

FIG. 7 is a flowchart illustrating an operation example of medium reading processing executed by the medium conveying apparatus 100. The medium reading processing is achieved by cooperation between the processing circuit 150 and the components in the medium conveying apparatus 100 in accordance with a program stored in the storage device 140.

First, the control unit 151 stands by until an operation signal providing an instruction to read a medium is received (S101). The operation signal is fed to the control unit 151 from the operation device 105 in response to input of a read instruction of a medium to the operation device 105 by a user. The operation signal may be fed from the information processing device through the interface device 132 in response to input of a read instruction to the information processing device by a user. When receiving the operation signal, the control unit 151 initializes the conveyed medium count to 0, which is stored in the storage device 140.

Next, the control unit 151 determines whether or not a medium is placed on the loading tray 103 on the basis of a first medium signal output from the first medium sensor 111 (S102). When a medium is not placed (S102—No), the control unit 151 ends the medium reading processing.

When a medium is placed (S102—Yes), the control unit 151 raises the loading tray 103 to a position allowing feed of the medium by driving a motor for moving the loading tray 103. The control unit 151 feeds and conveys the medium placed on the loading tray 103 by rotating the pick roller 112, the feed roller 113, the brake roller 114, and the first to eighth conveyance rollers 116a to 116h by driving the motor 131 (S103).

Next, the detection unit 152 increments the conveyed medium count by one stored in the storage device 140 (S104).

Next, the detection unit 152 executes detection processing (S105). The detection unit 152 detects a skew of a medium conveyed by the conveying unit in the detection processing. Details of the detection processing will be described later.

Next, the control unit 151 determines whether or not the rear edge of the medium has passed the imaging position of the imaging device 118 (S106). For example, the control unit 151 periodically acquires a second medium signal from each second medium sensor 115. The control unit 151 determines that the rear edge of the medium has passed the position of the second medium sensor 115 when the signal value of any second medium signal changes from a value indicating existence of a medium to a value indicating nonexistence of a medium. When a predetermined time elapses after the rear edge of the medium passes the position of the second medium sensor 115, the control unit 151 determines that the rear edge of the medium has passed the imaging position. The predetermined time is set to a time acquired by adding a margin to the time required for the medium to be conveyed from the second medium sensor 115 to the imaging position. When the rear edge of the medium has not yet passed the imaging position (S106—No), the control unit 151 returns the processing to S105 and repeats the processing in S105 and S106.

When the rear edge of the medium has passed the imaging position (S106—Yes), the control unit 151 acquires an input image from the imaging device 118. The control unit 151 transmits the acquired input image to the information processing device through the interface device 132 (S107).

Next, the control unit 151 determines whether or not a medium is placed on the loading tray 103 on the basis of a first medium signal output from the first medium sensor 111 (S108). When a medium is placed (S108—Yes), the control unit 151 returns the processing to S104 and repeats the processing in S104 to S108. When a medium is not placed (S108—No), the control unit 151 stops the motor 131 (S109).

Next, the calculation unit 153 and the output unit 154 execute notification processing (S110) and ends the medium reading processing. In the notification processing, the calculation unit 153 calculates an occurrence frequency of skew, and the output unit 154 outputs a notification or the like related to maintenance of the feed roller 113 on the basis of the calculated occurrence frequency. Details of the notification processing will be described later.

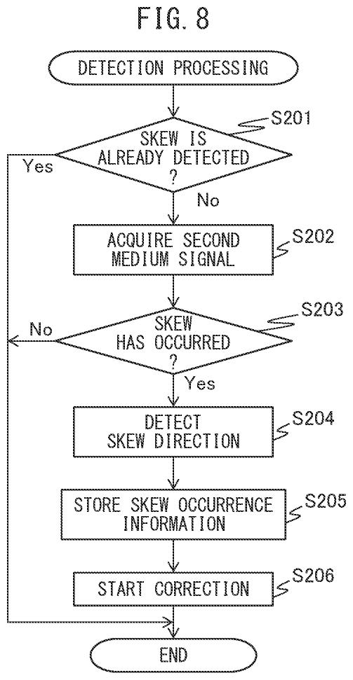

FIG. 8 is a flowchart illustrating an operation example of the detection processing. The detection processing is executed in S105 in the medium reading processing.

First, the detection unit 152 determines whether or not a skew of a medium currently being conveyed is already determined to have occurred (S201). When a skew of the medium currently being conveyed is already determined to have occurred (S201—Yes), the detection unit 152 ends the detection processing.

When a skew of the medium currently being conveyed is not yet determined to have occurred (S201—No), the detection unit 152 acquires a second medium signal from each second medium sensor 115 (S202).

Next, the detection unit 152 determines whether or not a skew of the medium has occurred (S203). The detection unit 152 determines whether or not the front edge of the medium is detected by each second medium sensor 115. When the signal value of a second medium signal is changed from a value indicating existence of a medium to a value indicating nonexistence of a medium, the detection unit 152 determines that the front edge of the medium is detected by a second medium sensor 115 outputting the second medium signal. The detection unit 152 determines whether the second medium sensor 115 first detecting the front edge of the medium is a second medium sensor 115 arranged outside or the second medium sensor 115 arranged inside. When the front edge of the medium is first detected by a second medium sensor 115 arranged outside, the detection unit 152 calculates the time from detection of the front edge of the medium by the second medium sensor 115 arranged outside to detection of the front edge of the medium by the second medium sensor 115 arranged inside. When the calculated time is greater than or equal to a predetermined time, the detection unit 152 determines that a skew has occurred. The predetermined time is appropriately set on the basis of an allowable tilt of a medium when the medium is imaged, time intervals at which the second medium sensor 115 outputs second medium signals, and the like.

When the second medium sensor 115 first detecting the front edge part of the medium is the second medium sensor 115 arranged inside or the calculated time is less than the predetermined time, the detection unit 152 determines that a skew has not occurred. When none of the second medium sensors 115 have detected the front edge of the medium or the predetermined time has not elapsed since first detection of the front edge of the medium by a second medium sensor 115 arranged outside, the detection unit 152 does not yet determine whether or not a skew has occurred. When a skew is not determined to have occurred (S203—No), the detection unit 152 ends the detection processing.

When a skew is determined to have occurred (S203—Yes), the detection unit 152 detects a skew direction in which the conveyed medium is tilted (S204). When the medium is first detected by a second medium sensor 115 arranged most leftward when viewed from the upstream side in the medium conveying direction A2, the detection unit 152 determines that a skew causing a rightward tilt of the medium (hereinafter referred to as a rightward skew) has occurred. When the medium is first detected by a second medium sensor 115 arranged most rightward when viewed from the upstream side in the medium conveying direction A2, the detection unit 152 determines that a skew causing a leftward tilt of the medium (hereinafter referred to as a leftward skew) has occurred.

Next, the detection unit 152 stores occurrence of a skew and the skew direction for the medium currently being conveyed into the storage device 140 as skew occurrence information (S205).

Next, the control unit 151 starts correction of the skew of the medium (S206) and ends the detection processing. The control unit 151 corrects the skew of the medium by causing circumferential speeds of a plurality of feed rollers 113 to be different from each other. The control unit 151 changes the circumferential speeds of the feed rollers 113 in such a way that the circumferential speed of a feed roller 113 placed on the side where progression of the medium is delayed in the width direction A4 orthogonal to the medium conveying direction is faster than the circumferential speed of a feed roller 113 placed on the preceding side. The control unit 171 controls the motor 131 in such a way as to rotate the feed rollers 113 at the changed circumferential speeds for a predetermined period.

The control unit 151 may determine, on the basis of the input image, whether or not the skew is corrected when an input image is acquired in S107 in FIG. 7 in the case of executing the skew correction. For example, the control unit 151 detects a medium from the input image with a known image processing technology. The control unit 151 determines whether or not the skew is corrected depending on whether or not the shape of the medium detected from the input image is a rectangle. When the skew is not corrected, the detection unit 152 may output a notification that a skew has occurred. For example, the detection unit 152 outputs the notification by generating display data of the notification and feeding the display data to the display device 106. The detection unit 152 may output the notification by transmitting the display data to the information processing device through the interface device 132.

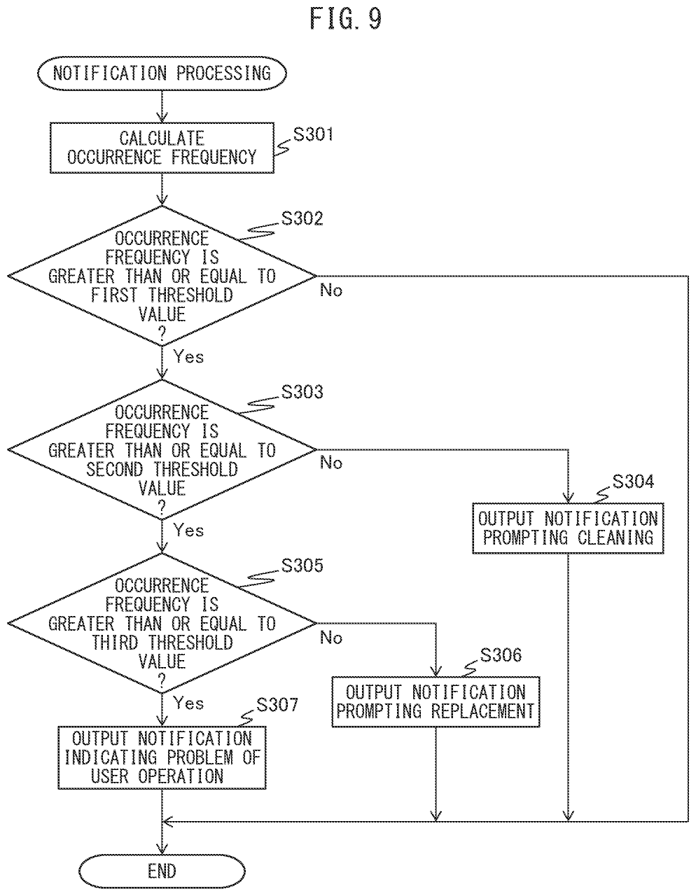

FIG. 9 is a flowchart illustrating an example of a flow of the notification processing. The notification processing is executed in S110 in the medium reading processing.

First, the calculation unit 153 calculates an occurrence frequency of skew for each skew direction on the basis of the skew detection result in the detection processing by the detection unit 152 (S301). The calculation unit 153 calculates an occurrence frequency of skew for each skew direction by dividing the number of skews for each direction indicated by the skew occurrence information stored in S205 in the determination processing by the conveyed medium count calculated in S104 in the medium reading processing.

Next, the output unit 154 determines whether or not the occurrence frequency is equal to or a greater than a first threshold value (S302). When the occurrence frequency is less than the first threshold value (S302—No), the output unit 154 ends the notification processing without outputting any notifications.

When the occurrence frequency is greater than or equal to the first threshold value (S302—Yes), the output unit 154 determines whether or not the occurrence frequency is greater than or equal to a second threshold value greater than the first threshold value (S303). When the occurrence frequency is less than the second threshold value (S303—No), the output unit 154 outputs a notification prompting cleaning of the feed roller 113 to the user (S304) and ends the notification processing. For example, the output unit 154 outputs the notification by generating display data of the notification prompting cleaning of the feed roller 113 and feeding the display data to the display device 106. The output unit 154 may output the notification by transmitting the display data to the information processing device through the interface device 132. The notification prompting cleaning of the feed roller 113 is an example of a first notification.

When the occurrence frequency is greater than or equal to the second threshold value (S303—Yes), the output unit 154 determines whether or not the occurrence frequency is greater than or equal to a third threshold value greater than the second threshold value (S305). When the occurrence frequency is less than the third threshold value (S305—No), the output unit 154 outputs a notification prompting replacement of the feed roller 113 to the user (S306) and ends the notification processing. The notification prompting replacement of the feed roller 113 is another example of a first notification.

When the occurrence frequency is greater than or equal to the third threshold value (S305—Yes), the output unit 154 outputs a notification indicating a problem of operation by a user (S307) and ends the notification processing. The notification indicating a problem of operation by a user is a notification indicating a skew has occurred due to a factor other than the feed roller 113. For example, the notification indicates that the user has placed the medium on the loading tray 103 in a tilted manner. The notification indicating the problem is an example of a second notification.

The first threshold value, the second threshold value, and the third threshold value are set on the basis of a relation between contamination of the feed roller 113 and an occurrence frequency of skew. For example, the first threshold value is set to a value between an average occurrence frequency of skew when the feed roller 113 has no contamination and an average occurrence frequency of skew when the feed roller 113 has contamination that can be eliminated by cleaning. The second threshold value is set to a value between an average occurrence frequency of skew when the feed roller 113 has contamination that can be eliminated by cleaning and an average occurrence frequency of skew when the feed roller 113 has contamination that cannot be eliminated by cleaning or when the feed roller 113 is abraded. The third threshold value is set to a value greater than an average occurrence frequency of skew when the feed roller 113 has contamination that cannot be eliminated by cleaning or when the feed roller 113 is abraded. For example, the first threshold value, the second threshold value, and the third threshold value are set to 60%, 80%, and 95%, respectively.

As described above, the medium conveying apparatus 100 outputs a notification related to maintenance of the feed roller 113 or a notification not related to maintenance on the basis of an occurrence frequency of skew. Consequently, the medium conveying apparatus 100 can more suitably notify a user of an instruction related to the feed roller 113.

Specifically, friction between a roller surface of the feed roller 113 and a medium decreases when the feed roller 113 is contaminated, and therefore a force of the feed roller 113 pushing out the medium in the medium conveying direction A2 decreases. When only part of a plurality of feed rollers 113 is contaminated, the medium is not uniformly pushed out in the width direction A4, and therefore a skew of the medium occurs. In this case, a cleaning instruction or a replacement instruction of the feed roller 113 needs to be notified to the user.

Even when the feed roller 113 is not contaminated, a skew of a medium may occur due to user operation. For example, when the user places a medium on the loading tray 103 in a tilted manner, a skew of the medium occurs. In this case, a problem of operation by the user needs to be notified to the user.

A user normally places media on the loading tray 103 in an aligned state. Therefore, when a skew of a medium occurs due to operation by a user, a skew occurs in almost every medium and the occurrence frequency of skew increases. The medium conveying apparatus 100 outputs a notification indicating a problem of user operation when the occurrence frequency of skew is too high and outputs a cleaning instruction or a replacement instruction only when the feed roller 113 is highly likely to be contaminated. Since the user no longer feels troublesomeness by being notified of a cleaning instruction or a replacement instruction even when there is no need for cleaning or replacement, the medium conveying apparatus 100 can improve user convenience.

Further, the medium conveying apparatus 100 detects a skew direction in which a medium is skewed and calculates the occurrence frequency of skew for each skew direction. Consequently, the medium conveying apparatus 100 suitably detects a skew based on contamination of one of the feed rollers 113 and enables timely notification of a cleaning instruction or a replacement instruction of the feed roller 113 to a user. Specifically, when a skew is caused by contamination of a feed roller 113, only a skew in a direction in which the contaminated feed roller 113 is placed occurs. Accordingly, when skews of a similar level in different directions occur, it is highly likely that the skews occur due to a factor other than contamination of the feed roller 113, such as a misaligned tilt of media. By calculating an occurrence frequency of skew for each skew direction, the medium conveying apparatus 100 can notify a user of a cleaning instruction or a replacement instruction only when the feed roller 113 is highly likely to be contaminated.

Further, the medium conveying apparatus 100 outputs a notification prompting cleaning of the feed roller 113 as the notification related to maintenance when the occurrence frequency is greater than or equal to the first threshold value. Consequently, the medium conveying apparatus 100 enables timely notification of a cleaning instruction of the feed roller 113 to a user. Specifically, friction decreases only in part of the roller surface when a contamination adheres to the feed roller 113, and therefore the occurrence frequency of skew is low. By outputting a notification prompting cleaning of the feed roller 113 when the occurrence frequency is low, the medium conveying apparatus 100 can notify a user of a cleaning instruction when a contamination that can be handled by cleaning adheres to the feed roller 113.

Further, the medium conveying apparatus 100 outputs a notification prompting replacement of the conveyance roller as a notification related to maintenance when the occurrence frequency is greater than or equal to the second threshold value greater than the first threshold value. Consequently, the medium conveying apparatus 100 enables timely prompting of replacement of the feed roller 113 to a user when cleaning of the feed roller 113 cannot inhibit occurrence of a skew. Specifically, when the feed roller 113 is worn out and particularly when the roller is worn out due to use over a long period of time, most of the roller surface is normally worn out evenly, and therefore the occurrence frequency of skew is high. By outputting a notification prompting replacement of the feed roller 113 when the occurrence frequency is high, the medium conveying apparatus 100 can notify a user of a replacement instruction when the feed roller 113 is worn out to a degree that replacement is required.

Further, when the occurrence frequency is greater than or equal to the third threshold value greater than the second threshold value, the medium conveying apparatus 100 outputs a notification indicating a problem of operation by a user as a notification not related to maintenance. Consequently, the medium conveying apparatus 100 prevents notification of an unnecessary cleaning instruction or an unnecessary replacement instruction to a user as much as possible when a skew is not caused by contamination of the feed roller 113. The medium conveying apparatus 100 may not output any notifications when the occurrence frequency is greater than or equal to the third threshold value greater than the second threshold value.

While the feed roller 113 is placed above the brake roller 114 and media placed on the loading tray 103 are sequentially fed from the upper side, according to the aforementioned embodiment, the feed roller may be placed below the brake roller in such a way that media placed on the loading tray are sequentially fed from the lower side.

While the notification processing is executed when conveyance of every medium placed on the loading tray 103 is completed in the medium reading processing, according to the aforementioned embodiment (S110 in FIG. 7), the medium conveying apparatus 100 may execute the notification processing every time a predetermined number of media are conveyed. Consequently, the notification processing is not executed when reliability of occurrence frequency information is low as is the case when the number of media placed on the loading tray 103 is low, the medium conveying apparatus 100 can more timely notify a user of a cleaning instruction or a replacement instruction.

While the calculation unit 153 calculates the occurrence frequency of skew for each skew direction, according to the aforementioned embodiment (S301 in FIG. 9), the calculation unit 153 may calculate the occurrence frequency of skew regardless of the skew direction.

The detection unit 152 detects a skew of a medium conveyed by the feed roller 113, according to the aforementioned embodiment (S203 in FIG. 8). However, the detection unit 152 may detect a skew of a medium conveyed by the pick roller 112, the brake roller 114, or the first to eighth conveyance rollers 116a to 116h. In that case, a driving mechanism of each roller has a structure similar to the driving mechanism of the feed roller 113 and each roller is removably provided on a shaft of the roller. Further, each roller is independently provided to be rotatable. Further, a medium sensor similar to the second medium sensor 115 is provided on the downstream side of each roller, and the detection unit 152 detects a skew of a medium conveyed by the roller on the basis of a medium signal acquired from the medium sensor. In this case, the pick roller 112, the brake roller 114, or the first to eighth conveyance rollers 116a to 116h are examples of a conveyance roller, and each roller and the driving mechanism of the roller constitute an example of a conveying unit.

The brake roller 114 is used as a roller facing the feed roller 113, and the first to eighth driven rollers 117a to 117h are used as rollers facing the first to eighth conveyance rollers 116a to 117h, according to the aforementioned embodiment. However, the feed roller 113 and the first to eighth conveyance rollers 116a to 116h may be provided to face pads instead of rollers.

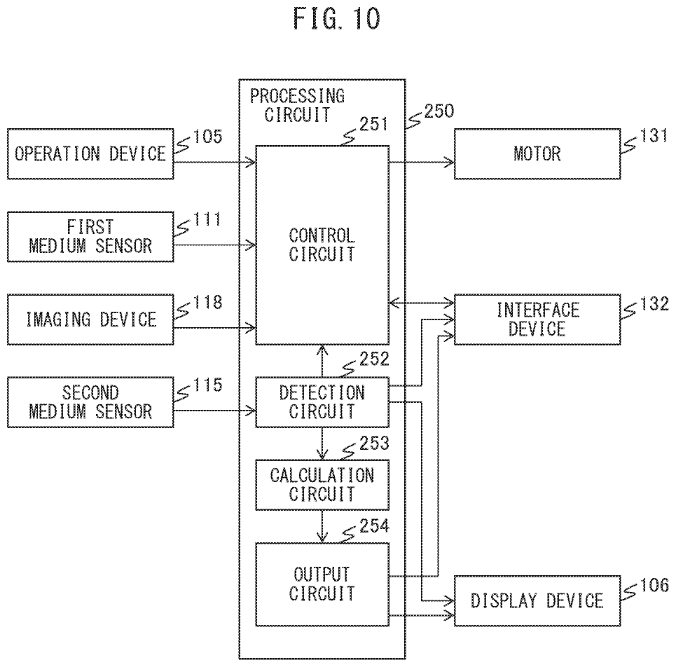

FIG. 10 is a diagram illustrating a schematic configuration of a processing circuit 250 in a medium conveying apparatus according to another embodiment. The processing circuit 250 is used in place of the processing circuit 150 in the medium conveying apparatus 100 and executes the medium reading processing. The processing circuit 250 includes a control circuit 251, a detection circuit 252, a calculation circuit 253, and an output circuit 254. Each of these components may be independently configured with an integrated circuit, a microprocessor, firmware, etc.

The control circuit 251 is an example of a control unit and has a function similar to that of the control unit 151. The control circuit 251 receives an operation signal from an operation device 105, a first medium signal from a first medium sensor 111, and a correction signal for correcting a skew from the detection circuit 252 and controls a motor 131 on the basis of the received signals. Further, the control circuit 251 receives an input image from an imaging device 118, stores the image into a storage device 140, and transmits the image to an information processing device through an interface device 132.

The detection circuit 252 is an example of a detection unit and has a function similar to that of the detection unit 152. The detection circuit 252 receives a second medium signal from a second medium sensor 115. The detection circuit 252 detects a skew and a skew direction of a medium on the basis of the received signal, outputs a conveyed medium count and skew occurrence information to the calculation circuit 253, and outputs a correction signal to the control circuit 251. Further, the detection circuit 252 outputs display data of a notification that a skew has occurred to a display device 106 or the interface device 132.

The calculation circuit 253 is an example of a calculation unit and has a function similar to that of the calculation unit 153. The calculation circuit 253 acquires a conveyed medium count and skew occurrence information from the detection circuit 252, calculates an occurrence frequency of skew on the basis of the acquired information, and outputs the occurrence frequency to the output circuit 254.

The output circuit 254 is an example of an output unit and has a function similar to that of the output unit 154. The output circuit 254 acquires an occurrence frequency from the calculation circuit 253 and outputs a notification related to maintenance or a notification different from a notification related to maintenance to the display device 106 or the interface device 132 on the basis of the acquired occurrence frequency.

As described above, the medium conveying apparatus enables timely notification of a cleaning instruction or a replacement instruction related to the feed roller 113 to a user when the processing circuit 250 is used as well.

It should be understood by a person skilled in the art that various changes, substitutions, and modifications can be made to the present invention without departing from the spirit and scope of the present invention. For example, the aforementioned embodiments and modified examples thereof may be implemented in combination as appropriate.

According to some embodiments, the medium conveying apparatus, the control method, and the computer-readable, non-transitory medium storing the computer program, can more suitably notify a user of an instruction related to a conveyance roller.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. A medium conveying apparatus comprising:
a conveying unit including a conveyance roller to convey a medium; and
a processor to
detect a skew of the medium conveyed by the conveying unit,
calculate an occurrence frequency of skew based on a detection result, and
output a first notification related to maintenance of the conveyance roller or a second notification not related to the maintenance based on the occurrence frequency.

2. The medium conveying apparatus according to claim 1, wherein the processor further detects a skew direction in which the medium is skewed, and the occurrence frequency of skew is calculated for the each skew direction.

3. The medium conveying apparatus according to claim 1, wherein the processor outputs a notification prompting cleaning of the conveyance roller as the first notification when the occurrence frequency is greater than or equal to a first threshold value.

4. The medium conveying apparatus according to claim 3, wherein
the conveyance roller is removable from the conveying unit, and
a notification prompting replacement of the conveyance roller is output as the first notification when the occurrence frequency is greater than or equal to a second threshold value greater than the first threshold value.

5. The medium conveying apparatus according to claim 4, wherein the processor outputs a notification indicating a problem of operation by a user as the second notification when the occurrence frequency is greater than or equal to a third threshold value greater than the second threshold value.

6. A control method for a medium conveying apparatus including a conveying unit including a conveyance roller to convey a medium, the control method comprising:
detecting a skew of a medium conveyed by the conveying unit;
calculating an occurrence frequency of skew based on a detection result; and
outputting a first notification related to maintenance of the conveyance roller or a second notification not related to the maintenance based on the occurrence frequency.

7. The control method according to claim 6, further comprising detecting a skew direction in which the medium is skewed, and wherein the occurrence frequency of skew is calculated for the each skew direction.

8. The control method according to claim 6, wherein a notification prompting cleaning of the conveyance roller is output as the first notification when the occurrence frequency is greater than or equal to a first threshold value.

9. The control method according to claim 8, wherein
the conveyance roller is removable from the conveying unit, and
a notification prompting replacement of the conveyance roller is output as the first notification when the occurrence frequency is greater than or equal to a second threshold value greater than the first threshold value.

10. The control method according to claim 9, wherein a notification indicating a problem of operation by a user is output as the second notification when the occurrence frequency is greater than or equal to a third threshold value greater than the second threshold value.

11. A computer-readable, non-transitory medium storing a computer program, the computer program causes a medium conveying apparatus including a conveying unit including a conveyance roller to convey a medium, to execute a process, the process comprising:
detecting a skew of a medium conveyed by the conveying unit;
calculating an occurrence frequency of skew based on a detection result; and
outputting a first notification related to maintenance of the conveyance roller or a second notification not related to the maintenance based on the occurrence frequency.

12. The computer-readable, non-transitory medium according to claim 11, wherein the process further comprising detecting a skew direction in which the medium is skewed, and wherein the occurrence frequency of skew is calculated for the each skew direction.

13. The computer-readable, non-transitory medium according to claim 11, wherein
the conveyance roller is removable from the conveying unit, and
a notification prompting cleaning of the conveyance roller is output as the first notification when the occurrence frequency is greater than or equal to a first threshold value.

14. The computer-readable, non-transitory medium according to claim 13, wherein a notification prompting replacement of the conveyance roller is output as the first notification when the occurrence frequency is greater than or equal to a second threshold value greater than the first threshold value.

15. The computer-readable, non-transitory medium according to claim 14, wherein a notification indicating a problem of operation by a user is output as the second notification when the occurrence frequency is greater than or equal to a third threshold value greater than the second threshold value.
